(19) United States
(12) Patent Application Publication
(10) Pub. No.: US 2012/0272190 A1
(43) Pub. Date: Oct. 25, 2012

(54) Method and System for Graphically Enabled Service Oriented Architecture

(75) Inventors: Wayne P. O'Brien, Staunton, VA (US); Raimund Merkert, Ayer, MA (US)

(73) Assignee: RAYTHEON COMPANY, Waltham, MA (US)

(21) Appl. No.: 13/090,292

(22) Filed: Apr. 20, 2011

(51) Int. Cl. G06F 3/048

(52) U.S. Cl. 715/835

(57) ABSTRACT

The system relates to a method for graphically organizing and orchestrating mission-related services during mission execution. In one aspect of the method, a plurality of individual services are selected and stored in a registry. The individual services are then associated with a graphical representation and interface definition. In another aspect, the graphical representation of each service is displayed to a user, who can then interconnect the services using a display, thereby creating a mission-related application.

### TECHNICAL FIELD

This disclosure relates to a method and system for graphically organizing and orchestrating mission-related services. More specifically, this disclosure relates to a system and method for graphically organizing and orchestrating mission-related services stored in a centralized registry and associated with an icon and an interface facilitating a user graphically interconnecting the services to create a mission-related application.

### BACKGROUND OF THE INVENTION

A Service Oriented Architecture (SOA) generally provides a way for providers of services to make their services available while consumers search through registries of existing services to find, bind, and then invoke the respective services. Generally, a SOA is a flexible set of design principles used during the phases of systems development and architecture. An SOA-based architecture will provide a loosely coupled suite of services that can be used within multiple business domains particularly as a result of being able to integrate or orchestrate different services through their loosely coupled interfaces.

Generally, a consumer developing a higher-level application (typically a software developer) must search a number of different service registries to locate services. The developer would then need to select appropriate services and write code to orchestrate these services into the larger framework.

This is graphically depicted in FIG. 1. First, service providers publish their respective services to a registry. Consumers then search these registries looking for services. When a consumer finds an appropriate service, he will determine the proper way to interact with the service. The consumer generally writes software or other code to bind to the service. Upon completion of development, once the consumer has finished creating the higher-level application, the application will invoke the service in order to utilize it at runtime.

There are numerous advantages and uses of SOA. In fact, the Department of Defense has mandated that all systems support the Network-Centric Environment, and SOA is fundamental to realizing this. In this regard, the Defense Information Systems Agency (DISA) has been tasked with building the next generation of military command and control systems, which will utilize SOA. DISA' “The NECC Provisional Technical Transition Architecture Specification,” describing the provisional architecture is incorporated herein by reference.

However, current practice relies heavily on human intervention for the integration of services. Hence, there exists a need in the industry to overcome these problems and provide a method and system for graphically organizing and orchestrating mission-related services. Additionally, there exists a need to provide mission-related services in a registry associated with a graphical representation and interface definition.

### SUMMARY OF THE INVENTION

According to one embodiment of the present disclosure, a method of graphically organizing and orchestrating mission-related services is disclosed. In one aspect of the method, a plurality of individual services are selected and stored in a registry. The individual services are then associated with a graphical representation and interface definition. In another aspect, the graphical representation of each service is displayed to a user, who can then interconnect the services using a display, thereby creating a mission-related application through the visual orchestration of services.

An advantage of one embodiment of the disclosure may be the ability to graphically display mission-related services. An advantage of this approach may be the reduction and simplification of the human intervention previously required to integrate disparate services.

Another advantage of one embodiment of the disclosure may be the ability to allow users at all levels of technical capability to coordinate and orchestrate available services to create a mission-specific application.

Another advantage of one embodiment of the disclosure may be the ability to quickly revise and modify a mission-specific application as the mission evolves by utilizing additional services to facilitate quick coordination and orchestration of them into a mission-specific application.

Various embodiments of the disclosure may have none, some, or all of these advantages. Other technical advantages of the present disclosure may also be readily apparent to one skilled in the art.

### BRIEF DESCRIPTION OF THE DRAWINGS

For a more complete understanding of the present disclosure and its advantages, reference is now made to the following descriptions, taken in conjunction with the associated drawings, in which:

FIG. 1 is a block diagram depicting a prior art method of publishing, finding, binding, and invoking services in a SOA.

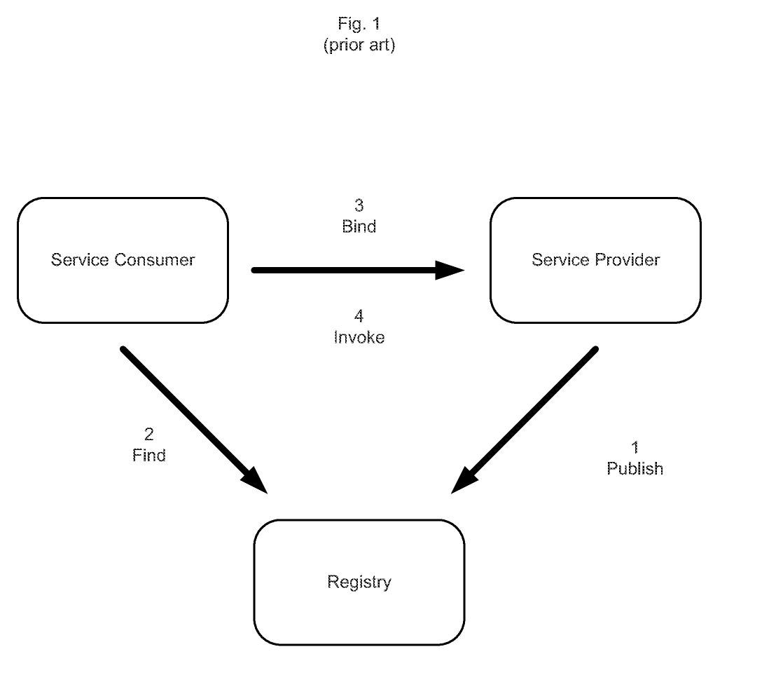

FIG. 2 is a flow chart illustrating one embodiment of a series of steps that may be performed in accordance with the teachings of the present disclosure.

FIG. 3 is a block diagram illustrating one embodiment of a system in accordance with the teachings of the present disclosure.

FIG. 4 is an illustration of a display being utilized in accordance with the teachings of the present disclosure.

FIG. 5 is an illustration of two displays being utilized in accordance with the teachings of the present disclosure.

### DETAILED DESCRIPTION OF THE DRAWINGS

The disclosed system relates to a system and method for graphically organizing and orchestrating mission-related services. In one aspect of the disclosure, mission-related services are provided in a centralized registry and associated with graphical representations and interfaces. Details regarding the system and associated method are discussed below.

For purposes of the present disclosure, a SOA may be in the form of an enterprise-scale information technology architecture for linking resources. A service is generally in the form of a software resource. That is, the service may be a software system designed to support interoperable machine-to-machine interaction over a network. The service may further have an interface described in a machine-processable, standards-based format. Generally, a service description is published along with the service to permit consumers to search, bind, and invoke the respective service.

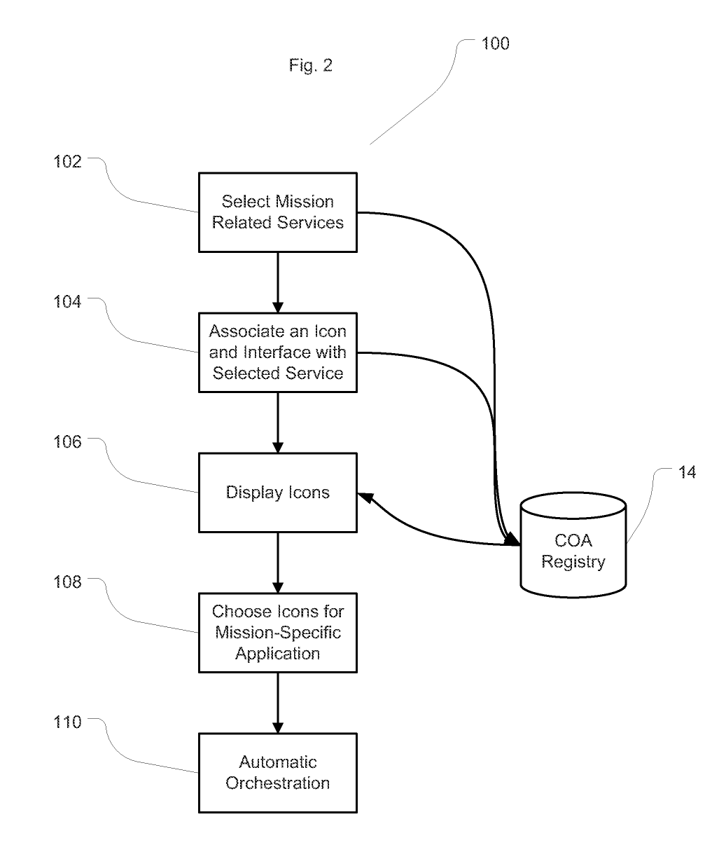

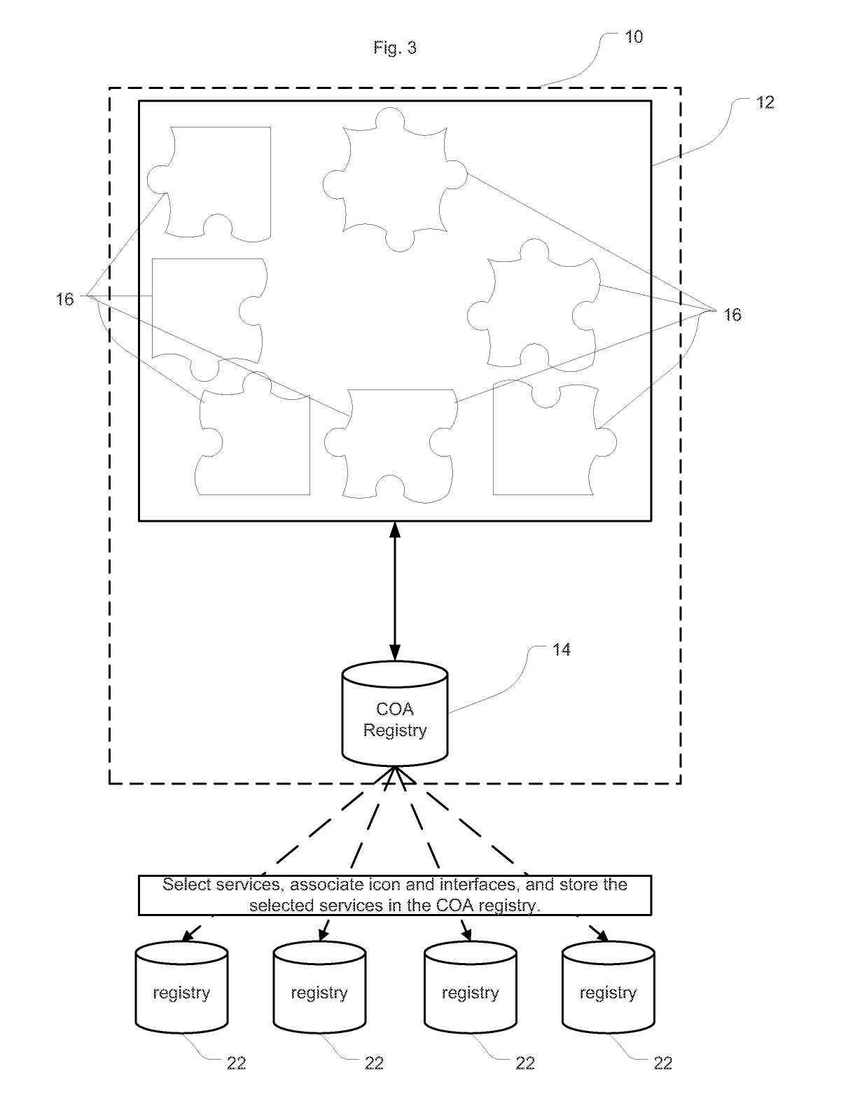

FIG. 2 discloses the steps that may be performed in a preferred embodiment of the present disclosure. The method begins at step 102 by selecting mission-related services. These mission-related services can be located in a plurality of disparate service registries 22 (for example, see FIG. 3). For purposes of the present disclosure, step 102 reduces the universe of available services that a consumer needs to be aware of. Rather than being concerned with the entire universe of available services, the universe of mission-related services is selected and stored in a centralized registry 14. Further, details about consumers and their required services may be included in centralized registry 14, which is not the case with service registries 22. These consumer details are used in the orchestration in step 110 below. This centralized registry 14 is also referred to herein as a community of action registry (COA Registry) 14.

The COA Registry 14 can be any system for storing information. In one preferred embodiment, the COA Registry 14 is a relational database which (as discussed below) stores selected services 16 and associated icons and interfaces.

Service providers would generally publish their services 16 in registries 22. As mentioned above, the service description is also generally available and searchable in the registries 22. For instance, the Web Services Description Language (WSDL) has been proposed as an XML format for describing network services as a set of endpoints operating on messages containing either document-oriented or procedure oriented information. The entire contents of the WSDL (including all associated information made available by the World Wide Web Consortium at http://www.w3.org/TR/wsdl) is incorporated by reference herein.

The registries 22 may be based upon Universal Description, Discovery, and Integration (UDDI). The UDDI specification, which began as an ad hoc consortium is now housed at the Organization for the Advancement of Structured Information Standards and is incorporated herein by reference. These registries 22 may expose information about interfaces (such as Application Programming Interfaces) for available services 16.

Thus, using the available service descriptions, the disclosed method may gather those services 16 which are related to a particular mission and store those services in the COA registry 14. Furthermore, services 16 may be dynamically added to the COA Registry during mission execution and displayed as services 16.

Returning to FIG. 2, at step 104 the mission-related services 16 are associated with an icon (or other graphical representation) and an interface. The icon can be any graphical device used to convey information to an end user. For exemplary purposes, such icons are depicted in the Figures as puzzle pieces, but any graphical representation would suffice.

The interface associated with the service 16 provides additional information or rules to permit automatic orchestration of related services. This additional information or rules may include the service description information, as well as other items to connect services 16 together. For instance, the additional information may include information needed for creating a workflow script. In one embodiment, this may be Business Process Execution Language instructions. These instructions may include execution orders for certain activities, triggering conditions, partners for external activities, compositions of services, bindings or any other similar information.

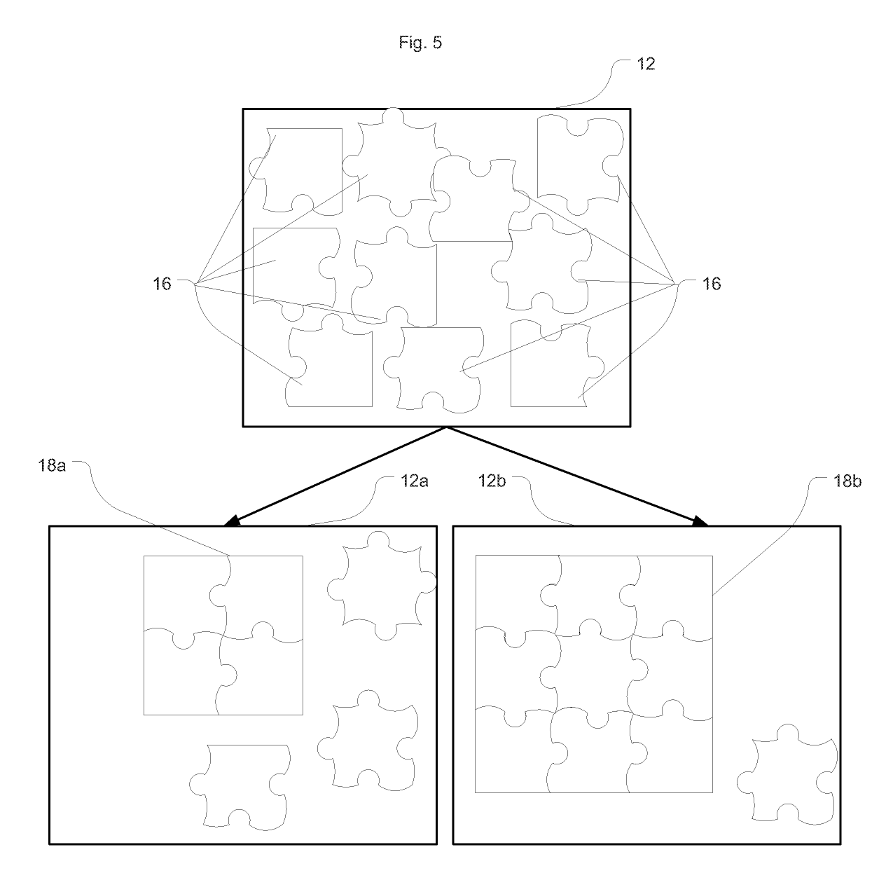

At step 106, the available icons are displayed on a display 12. As would be evident to one of skill in the art, numerous displays 12 could be used, and numerous different operators could all access the same COA Registry 14 through different displays 12 to build different mission-related applications (as shown in FIG. 5).

At step 108, the user chooses various icons 16 on the display 12 to select and then arrange their execution. Because the detailed information has been stored in the COA registry 14, the user need not understand how the services 16 integrate with one another. The display 12 does, however, provide a graphical depiction to the user of which services 16 can interact with one another. Thus, based upon the information stored in the COA Registry 14, the display 12 permits or prohibits the interconnection of services 16 as appropriate.

Finally, at step 110, when the user has finished graphically building the mission-specific application in the display 12, the system 10 may automatically orchestrate the services 16. In this context, orchestration may include automatic arrangement, coordination, and management of the services 16 selected and arranged by the user in the display.

The above discussion relates to the disclosure herein as combined with existing systems wherein service publishers publish their services in registries 22. In another embodiment, the system 10 and method disclosed herein can be used without need to integrate with services 16 in these other registries 22. In such an embodiment, service providers do not publish their services 16 to the registry 22. Rather, they publish their service 16 and associated additional information directly into the COA Registry 14. In this embodiment, the service providers generally know the consumers of the service 16, as well as the likely other related services to be integrated with the service. As such, the service provider can include the interface information in the COA Registry 14.

Consumers in this context can also be associated with various COA Registries 14. Thus, one class of consumers can be associated (or use) a first COA Registry 14, while a different class of user can use a second COA Registry 14. These different COA Registries 14 can contain different services 16 based upon the different domains of the consumers. For instance, if one class of consumer is accounting, while another class is human resources, the COA Registry 14 utilized by the accounting consumers can have accounting-related services, while the human resources COA Registry 14 can have human resources related services 16.

Thus, when a service provider initially creates a new service 16, the new service 16 can be put into an appropriate COA Registry 14. In the above example, if the new service 16 is accounting related, it would go into the accounting COA Registry 14, and automatically be available to all consumers using that registry.

FIG. 3 depicts a system 10 in accordance with one embodiment of the present disclosure. The system 10 includes a display 12, the COA Registry 14 and a processing device (not depicted).

The system 10 can be implemented on one or more computing systems, which can include a personal computer, a workstation, a network computer, a hand held device, or any other computing system. Further, the system 10 can be written as a software program in any appropriate computer language.

The display 12 could be any device for displaying information to a user including a computer display, television, a portable display (such as a portable computing device), a smart phone, or any other similar device. The processing device can be any computer processing unit, and could be a single central processing unit, or a number of processing units configured to operate either in sequence or in parallel. The processing device can be configured to execute software processes which implement the steps disclosed herein.

As would be understood by one of skill in the art, the system 10 would also include a memory capable of storing the steps necessary for the processing device to implement the steps disclosed herein. This memory could be in the form of memory resident within the processing device or in the form of standalone memory coupled to the processing unit via a communication path, such as a bus or a network.

The display 12, processing device and COA Registry 14 could be centrally located in a single location or remotely located from one another. Each could be directly connected to one another via any communication path, such as a bus or a network.

Returning to FIG. 3, a number of registries 22 are also depicted. These registries 22 would include the service descriptions discussed above. As shown in the figure, services are selected from these registries and then stored in the COA Registry 14 with associated icon and interface information. The analyst selecting and storing services 16 may also be aware of and store details about consumers of each service 16, some of which might also be providers of services 16 from registries 22.

An example display 12 is also depicted in FIG. 3. This display 12 depicts the various services 16 which are available in the COA Registry 14. In this example, the icons associated with the services 16 resemble puzzle pieces. Through such a graphical display, a user can see which “pieces” can interconnect with which other “pieces.” Thus, the user can drag the various pieces around the display and arrange them as the user desires.

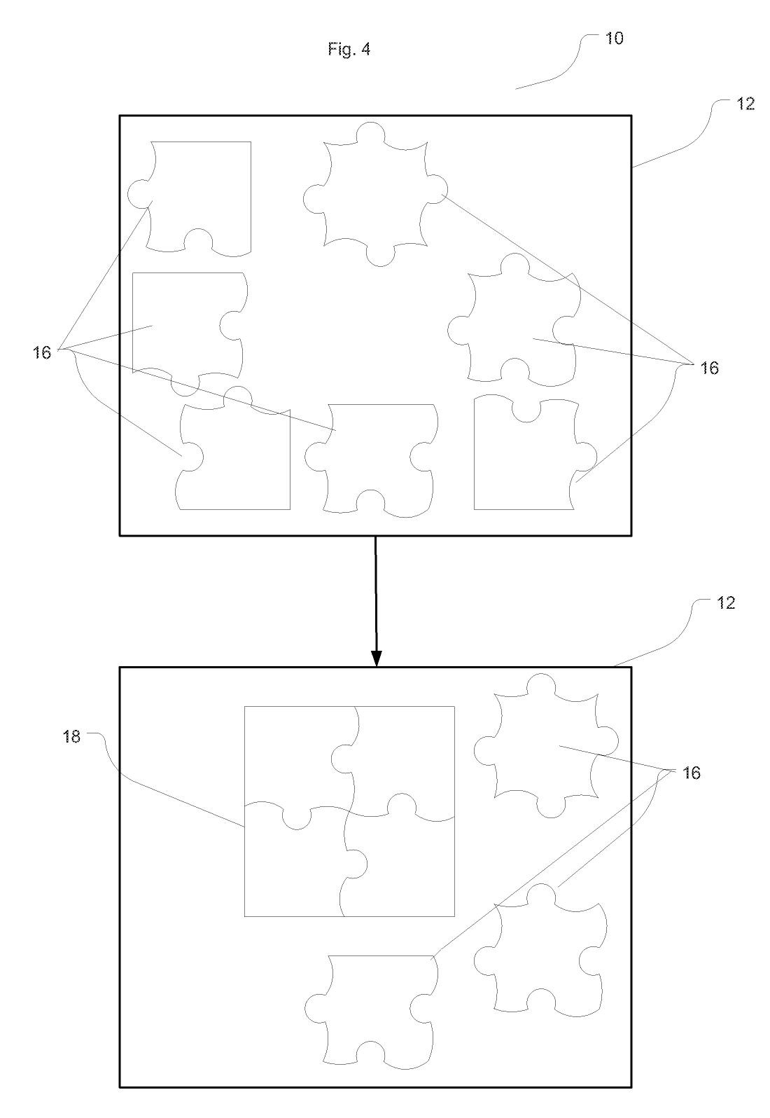

FIG. 4 depicts an example of such an arrangement. Here, a mission-specific application 18 has been built by the user by selecting four of the services 16 and dragging their respective icons into an appropriate configuration. Upon proper notification (such as by dragging the combined icons onto an orchestrate region of a display, or by the user clicking a button to orchestrate the services), the system 10 utilizes the information stored in the COA Registry 14 to orchestrate the selected services into the mission-specific application.

FIG. 5 provides a similar example to FIG. 4. In this case, two different users utilize separate displays 12a and 12b to build different mission-specific applications 18a and 18b using the same COA Registry 14, but using different services.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method of graphically organizing and displaying a plurality of different mission-related services, the method permitting the selection and orchestration of services to generate a mission-specific application, the method comprising the following steps:
providing a plurality of mission-related services;
associating an icon and an interface with each of the mission-related services;
storing the mission-related services and associated icons and interfaces in a database;
graphically displaying the icons associated with the mission-related services;
choosing a plurality of the mission-related services by way of the displayed icons; and
automatically orchestrating the chosen services by way of the interfaces to generate the mission-specific application.

2. A method of orchestrating services into an application, the method comprising providing a plurality of individual services;
associating an icon and an interface with each of the individual services;
displaying the icons; and
orchestrating the application by choosing a plurality of the icons, whereby the services are automatically orchestrated by way of the interfaces.

3. The method of claim 2 whereby the individual services are stored in a database.

4. The method of claim 3 whereby the database is a community of action registry.

5. The method of claim 2, whereby the step of providing a plurality of individual services further comprises:
selecting a plurality of mission-related services.

6. The method of claim 5 whereby the plurality of mission-related services is selected from at least two registries.

7. The method of claim 5 whereby the plurality of mission-related services are selected from a registry.

8. The method of claim 5 whereby the mission-related services are stored in a first database and the step of providing a plurality of individual services comprises storing the selected plurality of mission-related services in a second database.

9. The method of claim 2 whereby the interfaces comprise rules.

10. The method of claim 9 whereby the rules comprise instructions for connecting services.

11. A system for graphically organizing and orchestrating mission-related services comprising:
a registry;
a display; and
a processor interconnected to the registry and the display and configured to
store a plurality of mission-related services in the registry;
associate each mission-related service with an icon and an interface;
display the associated icons on the display; and
orchestrate a mission-related application.

12. The system of claim 11 wherein the registry is stored in a database.

13. The system of claim 11 wherein the mission-related services are first selected from a database.

14. The system of claim 11 wherein the display is a computer monitor.

15. The system of claim 11 wherein the display is a portable computer.

16. The system of claim 11 wherein the display is a smart phone.

17. The system of claim 11 wherein the processor is interconnected to the display via a network.

18. The system of claim 17 wherein the network is the internet.

19. The system of claim 11 wherein the registry utilizes the Universal Description, Discovery and Integration specification.

20. The system of claim 11 wherein the registry stores Business Process Execution Language instructions.
